(19) United States
(12) Patent Application Publication
(10) Pub. No.: US 2015/0334999 A1
(43) Pub. Date: Nov. 26, 2015

(54) ELECTRONIC BAIT DEVICE, SYSTEM AND METHOD

(71) Applicant: Western Marine Electronics Company, Woodinville, WA (US)

(72) Inventor: Bruce H. Blakey, Woodinville, WA (US)

(73) Assignee: Western Marine Electronics Company, Woodinville, WA (US)

(21) Appl. No.: 14/286,355

(22) Filed: May 23, 2014

(51) Int. Cl. A01K 85/01; A01K 69/06

(52) U.S. Cl. CPC A01K 85/01; A01K 69/06

(57) ABSTRACT

An electronic bait device includes a housing, one or more electroluminescent devices contained within the housing, a switch contained within the housing to control operation of the one or more electroluminescent devices, and a magnetic actuator secured to the housing to control the switch.

### BACKGROUND

1. Technical Field

The present disclosure relates to electronic bait devices and related systems, methods and articles.

2. Description of the Related-Art

Natural bait can be used to attract fish and other marine life, but natural bait can be expensive, particularly for commercial fishing purposes. Moreover, the use of natural bait for attracting marine life also reduces the amount of fish and other marine life available for human consumption.

Fish and other marine life may be attracted to electroluminescence. Some conventional lures emit electroluminescence to attract fish and other marine life. In addition, chemical sticks which emit colored light after the stick is snapped have also been used to attract fish and other marine life in commercial fishing operations. These chemical sticks, however, are not reusable. In addition, the chemical sticks are often not disposed of properly, and end up contributing to pollution in oceans and other water bodies.

### BRIEF SUMMARY

In an embodiment, an electronic bait device comprises a housing, one or more electroluminescent devices contained within the housing, a switch contained within the housing to control operation of the one or more electroluminescent devices, and a magnetic actuator secured to the housing to control the switch. In an embodiment, the magnetic actuator comprises an eyebolt having a magnetic portion. In an embodiment, the magnetic portion comprises one or more magnets embedded in the magnetic actuator. In an embodiment, the switch is configured to close when the magnetic actuator is secured in an activation position and to open when the magnetic actuator is not secured in the activation position. In an embodiment, the electronic bait device comprises a controller contained within the housing and coupled to the switch and to the one or more electroluminescent devices to control operation of the one or more electroluminescent devices based on a position of the switch. In an embodiment, the electronic bait device comprises one or more batteries and a charging terminal, wherein the controller is configured to control charging of the one or more batteries when a charging voltage is applied across the actuator and the charging terminal. In an embodiment, the electronic bait device comprises a material to substantially fill voids within the housing. In an embodiment, the electronic bait device comprises a fitting to secure the actuator to the housing. In an embodiment, the electronic bait device comprises a lock to secure the actuator in place with respect to the fitting. In an embodiment, the fitting has a threaded cavity configured to receive the magnetic actuator. In an embodiment, the switch is positioned in the threaded cavity of the fitting. In an embodiment, the one or more electroluminescent devices comprises an electroluminescent strip in a spiral configuration.

In an embodiment, a system comprises a trap to catch marine life and an electronic bait device secured to the trap. The electronic bait device includes a housing, one or more electroluminescent devices contained within the housing, a material to substantially fill gaps within the housing, and a controller coupled to the one or more electroluminescent devices to control operation of the one or more electroluminescent devices. In an embodiment, the controller comprises a switch contained within the housing and a magnetic actuator secured to the housing to control the switch, wherein the controller controls operation of the electroluminescent strip based on a position of the switch. In an embodiment, the magnetic actuator comprises an eyebolt having a magnetic portion. In an embodiment, the controller is at least partially outside the housing and is coupled to the one or more electroluminescent devices through one or more wires. In an embodiment, the material comprises a polymer.

In an embodiment, a method comprises determining whether to harvest a catch in marine life trap, when it is determined to harvest the catch in the marine life trap, activating at least one electroluminescent device to attract marine life out of the marine life trap, and harvesting marine life remaining in the marine life trap. In an embodiment, the method comprises activating at least one electroluminescent device to attract marine life into the marine life trap prior to determining whether to harvest the catch in the marine life trap. In an embodiment, the trap is a net and the at least one electroluminescent device to attract marine life out of the marine life trap is positioned near an opening in the net through which marine life may escape from the net.

### BRIEF DESCRIPTION OF THE SEVERAL VIEWS OF THE DRAWING(S)

FIG. 1 shows a functional block diagram of an embodiment of an electronic bait device.

FIGS. 2A, 2B and 2C show perspective views of an embodiment of an activation system of an electronic bait device.

FIG. 3 shows a functional block diagram of an embodiment of an electronic bait device.

FIG. 4 shows a functional block diagram of an embodiment of a crab trap employing an electronic bait device.

FIG. 5 shows a functional block diagram of an embodiment of a fishing net incorporating an electronic bait device.

FIG. 6 illustrates an embodiment of a method of fishing employing an embodiment of an electronic bait device or system.

### DETAILED DESCRIPTION

In the following description, certain details are set forth in order to provide a thorough understanding of various embodiments of devices, systems, methods and articles. However, one of skill in the art will understand that other embodiments may be practiced without these details. In other instances, well-known structures and methods associated with, for example, light-emitting diodes, processors, magnetic switches, etc., have not been shown or described in detail in some figures to avoid unnecessarily obscuring descriptions of the embodiments.

Unless the context requires otherwise, throughout the specification and claims which follow, the word “comprise” and variations thereof, such as “comprising,” and “comprises,” are to be construed in an open, inclusive sense, that is, as “including, but not limited to.”

Reference throughout this specification to “one embodiment,” or “an embodiment” means that a particular feature, structure or characteristic described in connection with the embodiment is included in at least one embodiment. Thus, the appearances of the phrases “in one embodiment,” or “in an embodiment” in various places throughout this specification are not necessarily referring to the same embodiment, or to all embodiments. Furthermore, the particular features, structures, or characteristics may be combined in any suitable manner in one or more embodiments to obtain further embodiments.

The headings are provided for convenience only, and do not interpret the scope or meaning of this disclosure or the claimed invention.

The sizes and relative positions of elements in the drawings are not necessarily drawn to scale. For example, the shapes of various elements and angles are necessarily not drawn to scale, and some of these elements are enlarged and positioned to improve drawing legibility. Further, the particular shapes of the elements as drawn are not necessarily intended to convey any information regarding the actual shape of particular elements, and have been selected solely for ease of recognition in the drawings. In addition, the use of geometric terms and the illustrations are not intended to indicate that embodiments have ideal geometric shapes.

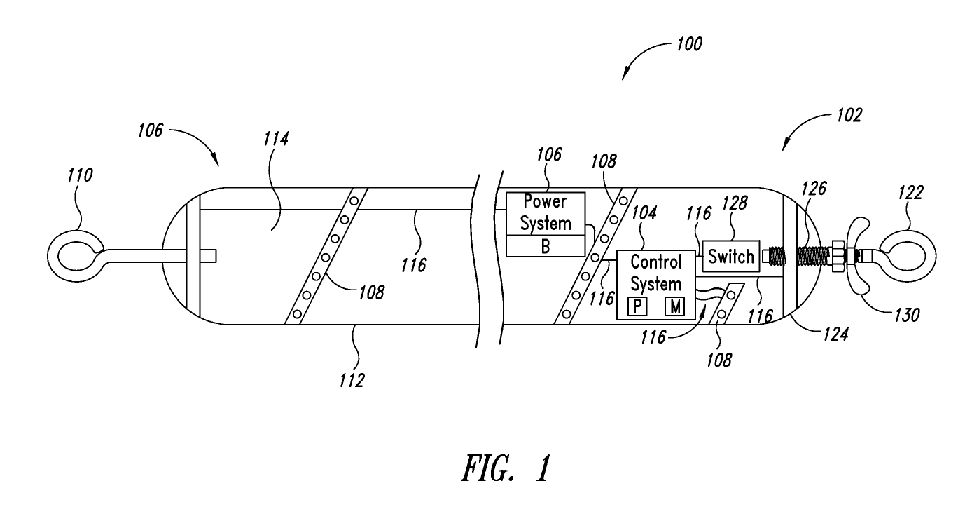

FIG. 1 shows a functional block of an embodiment of an electronic bait device 100. As illustrated, the electronic bait device 100 comprises a activation system 102, a control system 104, a power system 106, an electroluminescent system 108, a charging terminal 110, a housing 112 and a bus system 116. A material 114 is contained within the housing 112 to facilitate use of the electronic bait device 100 in high-pressure environments, such as when the device 100 is employed in deep water environments. The material 114 may substantially fill voids between other components of the electronic bait device in the housing.

As illustrated, the activation system 102 comprises an actuator 122, such as a threaded eyebolt, movably secured to the housing 112 by a fastener 124, such as a threaded fastener (e.g., a nut, a threaded plate, etc.). In an embodiment, the actuator 122 is magnetic or has a magnetic portion 126 comprised of one or more magnets. The activation system 102 also comprises a magnetic switch 128. In operation, the activation system 102 generates one or more control signals which may be used by the control system 104 to control operation or charging of the electronic bait device 100. For example, when the actuator 122 or the magnetic portion 126 of the actuator 122 is moved into an actuation position with respect to the switch 128 (e.g., moved closer to or away from the switch), the switch 128 may activate (e.g., close, open, toggle, generate a pulse, etc.). The control system 104 may respond to the activation of the switch by, for example, turning on the electronic bait device 100, entering a programming mode, etc. When the actuator 122 is moved into a deactivation position with respect to the switch 128 (e.g., away from or closer to the switch), the switch 128 may deactivate (e.g., open close, toggle, generate a pulse, etc.). The control system 104 may respond to the deactivation of the switch by, for example, turning off the electronic bait device 100, entering a charging mode, programming the electronic bait device, etc. For example, if the activation system 102 repeats an activation and deactivation cycle within a threshold time period, the control system 104 may enter a program mode, and the number of activation and deactivation cycles completed subsequent to entering the program mode may be used by the control system 104 to control the electroluminescent system 108 (e.g., to determine a electroluminescent sequence to be displayed by the electroluminescent system 108). Various threshold time periods and counters may be employed in the programming process.

In an embodiment, the actuator 122 is a threaded eyebolt and the fastener 124 is a threaded plate. When the eyebolt is twisted into the threaded plate to the actuation position, the control system 104 turns on the electronic bait device 100, and when the eyebolt is twisted out of the actuation position, the control system 104 turns off the electronic bait device 100. A positive lock 130 may be employed (e.g., a nut, such as a wing nut, etc.) to secure the actuator 122 in place (e.g., in the activation or the deactivation position). In one embodiment, the actuation position may be selected to so that substantially no void exists in the vicinity of the actuator 122 when the actuator 122 is in the actuation position. This may facilitate use of the electronic bait device 100 in deep water environments. For example, when an operator sees that the electronic bait device is turned on, the operator may know that the void has been filed and proceed to use the device 100 in deep water environments. In some embodiments, additional positive locks may be employed, for example, to prevent the actuator 122 from being completely removed from the fastener 124.

The control system 104 as illustrated comprises a processor P and a memory M. In some embodiments, the control system 104 may comprise state machines, discrete circuitry, look-up tables, etc., in addition to, or instead of, the illustrated processor P and/or the memory M. The components of the control system 104 may be used alone or in various combinations to implement the functionality of the control system 104. The control system 104 may be configured to control operation and charging of the electronic bait device 100, for example based on signals received from the actuation system 102, stored luminescent sequences, states of a state machine, etc., and various combinations thereof. The control system 104 may turn on or off the electroluminescent system 108, or may enter a charging mode, based on the position of the switch 128 or control signals received from the switch 128. In some embodiments, the control system 104 or the power system 106 may be configured to automatically enter a charging mode when the electronic bate device is connected to a charging station. For example, a voltage across the actuator 122 and the charging terminal 110 may be detected by the control system 104, which may respond to detection of the voltage by entering a charging mode of operation.

As illustrated, the power system 106 comprises one or more batteries B and a charging terminal 110. In some embodiments, the power system 106 may comprise processors, memory, state machines, discrete circuitry, look-up tables, etc., to control charging and discharging of the batteries. In some embodiments, the batteries B may take up a substantial portion of the interior space of the electronic bait device 100. The batteries B may comprise, for example, lithium ion batteries, nickel-metal hydride batteries, etc. In some embodiments, the control system 104 may be used, alone or in combination with the power system 106, to control charging and discharging of the batteries B of the power system 106. The components of the power system 106 may be used alone or in various combinations to implement the functionality of the power system 106.

The electroluminescent system 108 as illustrated comprises an electroluminescent strip, for example, an LED strip, which is in a spiral formation to facilitate providing luminescence in 360 degrees and to facilitate ease of coupling the electroluminescent system 108 to the control system 104 and the power system 106. For example, as illustrated only two connections are employed to couple the electroluminescent system 108 to other components of the electronic bait device 100. Other electroluminescent systems may be employed, including electroluminescent systems using multiple LED strips, individual LEDs, LCDs, etc., and various combinations thereof. For example, four substantially parallel strips could be employed substantially lengthwise and spaced approximately 90 degrees apart from each other to provide electroluminescence in substantially 360 degrees. The electronic bait device 100 may be configured to control the electroluminescent system 108 to, in operation, emit a single color (e.g., blue, green, orange, red, etc.), multiple colors, emit sequences of colors, sequences of the same color, colors which fade in and out, etc., and various combinations thereof. For example, blue and green may be more effective in attracting fish from a distance, electroluminescence patterns which simulate squid may be more effective in attracting predator fish species, etc.

The housing 112 may typically be transparent or semi-opaque and may comprise any suitable material for use in a desired environment (e.g., for use in deep sea environments). The housing may, for example, be made of any suitable polymer such as a thermoplastic polymer (e.g., polycarbonate, acrylonitrile, butadiene styrene (ABS), poly (vinyl chloride) PVC, polyethylene (PE), polypropylene (PP), polystyrene, etc., and copolymers thereof).

The material 114 may comprise, for example, a chemical compound such as a polymer or other chemical compound (e.g., urethane, ethyl carbomate, calcium sulfate hemihydrate, etc., and copolymers thereof). The material 114 facilitates preventing collapse of the electronic bait device 100 when it is subjected to high pressure, such as when the electronic bait device is employed in deep sea fishing environments, such as crab fishing environments.

The bus system 116 electrically couples components of the electronic bait device 100 together, for example, to provide control signals generated by the activation system 102 to the control system 104, to provide control signals of the control system 104 to the power system 106, to provide power supplied by the power system 106 to the electroluminescent system 108, to provide power received through the charging terminal 110 and the actuator 122 to the batteries B of power system 106, etc.

In some embodiments, when the electronic bait device 100 is in an operational mode (e.g., is configured to emit electroluminescence), little or substantially no current is conducted between the actuator 122 and the charging terminal 110 when the electronic bait device is immersed in water. Marine life may be repelled by stray currents, thus reducing the current and/or voltages between the exposed actuator 122 and charging terminal 110 may facilitate reducing any repelling of marine life during operation of the electronic bait device. In some embodiments, the voltage between the actuator 122 and the charging terminal 110 may be on the order of ten millivolts or less when the electronic bait device is in an operational mode.

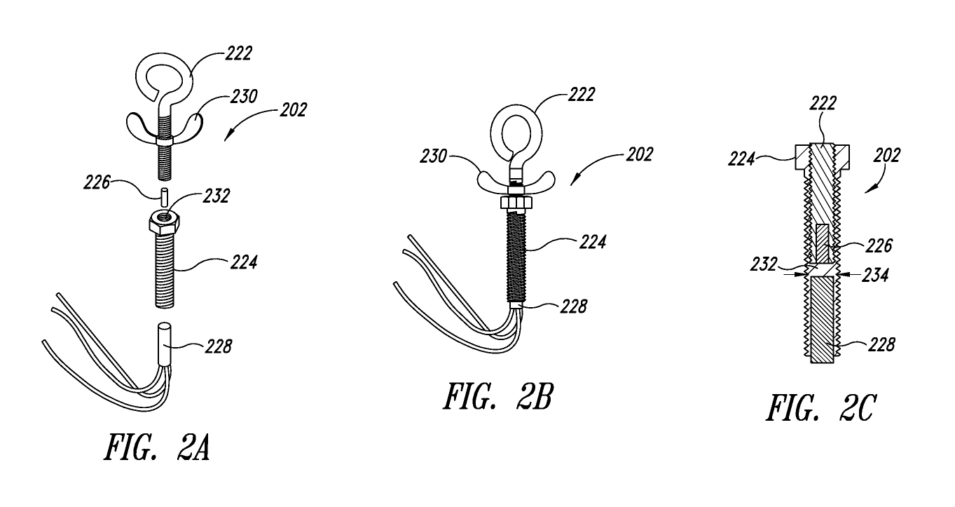

FIGS. 2A, 2B and 2C illustrate an embodiment of an activation system 202, that may be employed, for example, in the embodiment of FIG. 1. FIGS. 2A, 2B and 2C will be described herein with reference to FIG. 1 and by using similar reference numbers, however, the embodiment of FIGS. 2A, 2B and 2C may be employed in other embodiments of electronic bait devices.

The activation system 202 comprises an actuator 222 having a magnetic portion or a magnet 226 inserted into the actuator 222. The actuator 222 is secured to a fitting 224. The fitting 224 has a threaded chamber 232. A magnetic switch 228 is positioned in the threaded chamber 232. In some embodiments, the magnetic switch 228 may have a threaded housing (not shown) to secure the magnetic switch 228 in the threaded chamber 232 of the fitting 224. In operation, the actuator 222 is twisted into the threaded chamber 232 until the actuator 222 reaches an activation position 234, which causes the magnetic switch 228 to close. The activation position may be selected so that substantially no void exists between the magnetic switch 228 and the actuator 222 when the actuator 222 is in the activation position 234. In some embodiments, the fitting 224 may be configured to provide strength to the activation system to facilitate preventing collapse of the electronic bait device 100 in high pressure environments. Other activation systems may be employed in some embodiments, such as a remote-control activation system (e.g., a radio-frequency communication system).

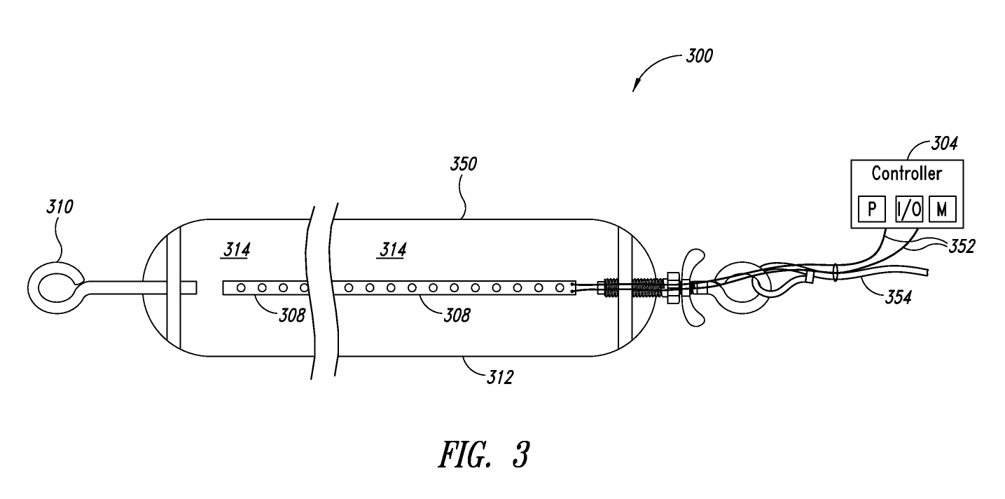

FIG. 3 illustrates an embodiment of an electronic bait system 300. The electronic bait system 300 comprises an electronic bait device 350. As illustrated, the electronic bait device 350 comprises an electroluminescent system 308 and a housing 312. A material 314 is contained within the housing 312 to facilitate use of the electronic bait device 350 in high-pressure environments, such as when the device 350 is employed in deep water environments. The electronic bait device 350 may employ an eyebolt 310 or other fastener to secure the electronic bait device to other objects (e.g., fishing lines, traps, nets, additional electronic bait devices, etc.).

As illustrated, the electronic bait system 300 comprises a controller or control system 304, which may be located, for example, on a ship (not shown). Wires 352 electrically couple the electroluminescent system 308 of the electronic bait device 350 to the controller 304. A cable 354 secures the electronic bait device, for example, to a ship, a buoy, a trap, etc. The wires 352 may be secured to the cable 354, may be embedded in the cable 354, etc.

The controller 304 as illustrated comprises a processor P, a memory M and an input/output system I/O. In some embodiments, the controller 304 may comprise state machines, discrete circuitry, look-up tables, etc., in addition to, or instead of, the illustrated processor P, the memory M and/or the input/output system I/O. The components of the control system 304 may be used alone or in various combinations to implement the functionality of the control system 304. The control system 304 may be configured to control operation of the electronic bait device 350, for example based on signals received from the input/output system I/O, stored luminescent sequences, states of a state machine, etc. The control system 304 provides power and may provide control signals to the electronic bait device 350 through the wires 352.

The electroluminescent system 308 as illustrated comprises an electroluminescent strip, for example, an LED strip. In some embodiment, the strip may be in a spiral formation to facilitate providing luminescence in 360 degrees and to facilitate ease of coupling the electroluminescent system 308 to the control system 304. Other electroluminescent systems may be employed, including electroluminescent systems using multiple LED strips, individual LEDs, LCDs, etc., and various combinations thereof. For example, four substantially parallel strips could be employed substantially lengthwise and spaced approximately 90 degrees apart from each other to provide electroluminescence in substantially 360 degrees. The electronic bait system 300 may be configured to control the electroluminescent system 308 to, in operation, emit a single color (e.g., blue, green, orange, red, etc.), multiple colors, emit sequences of colors, sequences of the same color, colors which fade in and out, etc., and various combinations thereof. For example, blue and green may be more effective in attracting fish from a distance, electroluminescence patterns which simulate squid may be more effective in attracting predator fish species, etc.

The housing 312 may typically be transparent or semi-opaque and may comprise any suitable material for use in a desired environment (e.g., for use in deep sea environments). The housing may, for example, be made of any suitable polymer such as a thermoplastic polymer (e.g., polycarbonate, acrylonitrile, butadiene styrene (ABS), poly (vinyl chloride) PVC, polyethylene (PE), polypropylene (PP), polystyrene, etc., and copolymers thereof).

The material 314 may comprise, for example, a chemical compound such as a polymer or other chemical compound (e.g., urethane, ethyl carbomate, calcium sulfate hemihydrate, polystyrene, etc., and copolymers thereof). The material 314 facilitates preventing collapse of the electronic bait device 350 when it is subjected to high pressure, such as when the electronic bait device is employed in deep sea fishing environments, such as crab fishing environments.

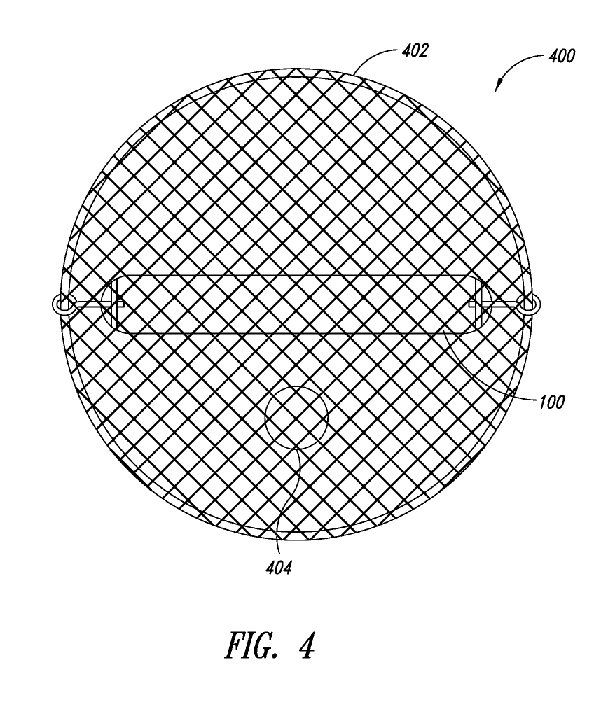

FIG. 4 illustrates an embodiment of a crab trap 400 employing an embodiment of an electronic bait device. For convenience, FIG. 4 is described with reference to the embodiment of an electronic bait device of FIG. 1. Other embodiments of electronic bait devices may be employed in crab traps, such as the embodiment of FIG. 3, and multiple electronic bait devices may be employed. For ease of illustration, only a portion of the frame 402 of the crab trap 400 is illustrated. An electronic bait device 100 is secured to the frame 402 of the crab trap 400, for example at or near a bait point 404 of the trap. The electronic bait device 100, in operation, emits electroluminescence which attracts crabs into the trap 400. In some embodiments, the crab traps may employ a scent device, live bait or combinations thereof in addition to the electronic bait device 100. The electronic bait device 100 may be configured, for example to emulate the bioluminescence of a squid (e.g., the electronic bait device may be configured to emit blue, green, red, yellow electroluminescence which fades in and out, mimicking natural bioluminescence, etc.). Other colors may be employed.

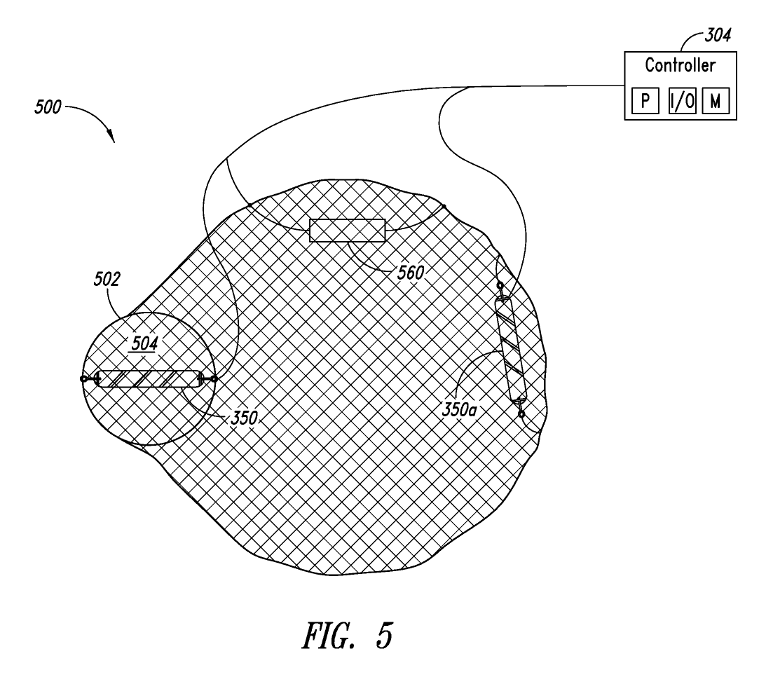

FIG. 5 illustrates an embodiment of net 500 employing an embodiment of an electronic bait device. For convenience, FIG. 5 is described with reference to the embodiment of an electronic bait system 300 of FIG. 3. An electronic bait device 350 is secured to a portion 502 of the net 500 adjacent to an opening 504 in the net, for example, an exclusion hole in the net, and is communicatively coupled to the controller 304. Other embodiments of electronic bait devices may be employed in nets, such as the embodiment of FIG. 1, and multiple electronic bait devices may be employed. For example, an additional electronic bait device 350a is secure to another portion of the net 500, for example at a bait point of the net 500. For ease of illustration, only a portion of the net 500 is illustrated (e.g., the loops of the netting are not shown). The electronic bait devices 350, 350a, in operation, emit electroluminescence which attracts fish and other marine life. The electronic bait device 350 may attract marine life to the opening 504 in the net. In some embodiments, the net may employ one or more scent devices or live bait or both in addition to the electronic bait devices 350, 350a. The electronic bait devices 350, 350a may be configured, for example, to emulate the bioluminescence of a squid (e.g., the electronic bait device may be configured to emit blue, green, red, yellow electroluminescence which fades in and out, mimicking natural bioluminescence, etc.). Other colors may be employed. The net 500 may employ other devices, such as the illustrated sensor 560, which is configured to send a signal when the net is full. For example, the sensor 560 may send a signal to the controller 304 to indicate the net is full. In some embodiments, the sensor 560 may be integrated into an electronic bait device, such as the electronic bait device 350 or the electronic bait device 350a.

In some embodiments, the electronic bait system 300 may be controlled so as to attract fish or other marine life into the net 500 or other trap, as well as to attract unwanted fish or other catch out of the net 500 or other trap. For example, it may be desirable to reduce the capture of certain fish, such as salmon, when fishing for other fish, such as pollock, using nets. Salmon, for example, swim faster than pollock. Thus, attracting fish to an opening hole in the net 500 prior to harvesting may reduce the number of salmon in the catch without significantly reducing the number of pollock in the catch.

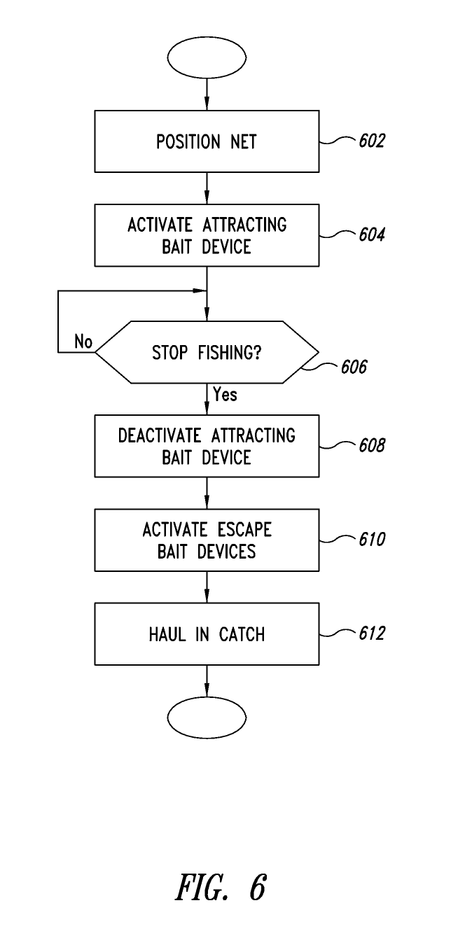

FIG. 6 illustrates an embodiment of a method 600 of catching fish. For ease of illustration, FIG. 6 will be described in the context of the fishing net 500 of FIG. 5 and the electronic bait system 300 of FIG. 3. Other catching devices and electronic bait systems may be employed. At 602, a net or other trap is positioned in a desired fishing ground. For example, a net 500 may be pulled through the fishing ground on a trawler. The method proceeds to 604.

At 604, an electronic bait system or device is activated to attract fish or other marine life into the net. For example, with reference to FIG. 5, the electronic bait device 350a may be activated by the controller 304 to attract fish into the net 500. In some embodiments, an electronic bait device or system may be activated before the net or other trap is positioned in the desired fishing ground. The method proceeds to 606.

At 606, a decision is made whether to stop fishing (e.g., whether to haul in the catch). In some embodiments, it may be determined to haul in the catch when a signal is received that indicates the net is nearing its capacity level (e.g., when a signal is received from a sensor such as the sensor 560 of FIG. 5 indicating the net 500 is full). A decision to stop fishing may be made for various other reasons, such as a change in the weather, etc. When it is determined to stop fishing, the method proceeds to 608.

At 608, an electronic bait device which attracts fish into the net may be deactivated. For example, electronic bait device 350a of FIG. 5 may be turned off. The method proceeds to 610.

At 610, an exclusion bait device may be activated. For example, the electronic bait device 350 of FIG. 5 may be turned on for a period of time. Salmon typically swim faster than pollock, and may be attracted to the opening 504 in the net 500, allowing salmon to escape from the net 500 before or as the net is being hauled in to, for example, a fishing trawler. The method proceeds to 612, where the catch is hauled in to, for example, the fishing trawler.

Some embodiments may take the form of or comprise computer program products. For example, according to one embodiment there is provided a computer readable medium comprising a computer program adapted to perform one or more of the methods or functions described above, such as detecting activation of an electronic bait device and controlling emission of electroluminescence after activation, etc. The medium may be a physical storage medium such as for example a Read Only Memory (ROM) chip, or a disk such as a Digital Versatile Disk (DVD-ROM), Compact Disk (CD-ROM), a hard disk, a memory, a network, or a portable media article to be read by an appropriate drive or via an appropriate connection, including as encoded in one or more barcodes or other related codes stored on one or more such computer-readable mediums and being readable by an appropriate reader device.

Furthermore, in some embodiments, some or all of the methods and/or functionality may be implemented or provided in other manners, such as at least partially in firmware and/or hardware, including, but not limited to, one or more application-specific integrated circuits (ASICs), digital signal processors, discrete circuitry, logic gates, state machines, standard integrated circuits, controllers (e.g., by executing appropriate instructions, and including microcontrollers and/or embedded controllers), field-programmable gate arrays (FPGAs), complex programmable logic devices (CPLDs), etc., as well as devices that employ RFID technology, and various combinations thereof. For example, embodiments of an electronic bait device may be implemented as discussed above (e.g., partially in hardware, partially with controllers executing instructions, etc.).

The various embodiments described above and in the various patents, applications and publications can be combined to provide further embodiments. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. An electronic bait device, comprising:
a housing;
one or more electroluminescent devices contained within the housing;
a switch contained within the housing to control operation of the one or more electroluminescent devices; and
a magnetic actuator secured to the housing to control the switch.

2. The electronic bait device of claim 1 wherein the magnetic actuator comprises an eyebolt having a magnetic portion.

3. The electronic bait device of claim 2 wherein the magnetic portion comprises one or more magnets embedded in the magnetic actuator.

4. The electronic bait device of claim 1 wherein the switch is configured to close when the magnetic actuator is secured in an activation position and to open when the magnetic actuator is not secured in the activation position.

5. The electronic bait device of claim 1, comprising a controller contained within the housing and coupled to the switch and to the one or more electroluminescent devices to control operation of the one or more electroluminescent devices based on a position of the switch.

6. The electronic bait device of claim 5, comprising:
one or more batteries; and
a charging terminal, wherein the controller is configured to control charging of the one or more batteries when a charging voltage is applied across the actuator and the charging terminal.

7. The electronic bait device of claim 1, comprising a material to substantially fill voids within the housing.

8. The electronic bait device of claim 1, comprising a fitting to secure the actuator to the housing.

9. The electronic bait device of claim 8, comprising a lock to secure the actuator in place with respect to the fitting.

10. The electronic bait device of claim 8 wherein the fitting has a threaded cavity configured to receive the magnetic actuator.

11. The electronic bait device of claim 10 wherein the switch is positioned in the threaded cavity of the fitting.

12. The electronic bait device of claim 1 wherein the one or more electroluminescent devices comprises an electroluminescent strip in a spiral configuration.

13. A system, comprising:
a trap to catch marine life; and
an electronic bait device secured to the trap, the electronic bait device including:
a housing;
one or more electroluminescent devices contained within the housing;
a material to substantially fill gaps within the housing; and
a controller coupled to the one or more electroluminescent devices to control operation of the one or more electroluminescent devices.

14. The system of claim 13 wherein the controller comprises:
a switch contained within the housing; and
a magnetic actuator secured to the housing to control the switch, wherein the controller controls operation of the electroluminescent strip based on a position of the switch.

15. The system of claim 14 wherein the magnetic actuator comprises an eyebolt having a magnetic portion.

16. The system of claim 13 wherein the controller is at least partially outside the housing and is coupled to the one or more electroluminescent devices through one or more wires.

17. The system of claim 13 wherein the material comprises a polymer.

18. A method, comprising:
determining whether to harvest a catch in marine life trap;
when it is determined to harvest the catch in the marine life trap, activating at least one electroluminescent device to attract marine life out of the marine life trap; and
harvesting marine life remaining in the marine life trap.

19. The method of claim 18, comprising:
activating at least one electroluminescent device to attract marine life into the marine life trap prior to determining whether to harvest the catch in the marine life trap.

20. The method of claim 18 wherein the trap is a net and the at least one electroluminescent device to attract marine life out of the marine life trap is positioned near an opening in the net through which marine life may escape from the net.
